(19) United States
(12) Patent Application Publication
(10) Pub. No.: US 2025/0351994 A1
(43) Pub. Date: Nov. 20, 2025

(54) PLATE WARMER APPARATUS

(71) Applicant: Haier US Appliance Solutions, Inc., Wilmington, DE (US)

(72) Inventor: Eric Scott Johnson, Louisville, KY (US)

(21) Appl. No.: 18/669,062

(22) Filed: May 20, 2024

(51) Int. Cl. A47J 36/24

(52) U.S. Cl. CPC A47J 36/2483

(57) ABSTRACT

A plate warmer includes a controller. The controller is in communication with an external device. A method of operating the plate warmer may include receiving data from the external device indicative of a heating instruction and/or detecting dishware placed within a heating zone of the plate warmer. The method further includes operating a heating element in response to at least one of the heating instruction and the detected dishware.

### FIELD OF THE INVENTION

The present subject matter relates generally to plate warming apparatus, and more particularly to systems and methods for controlling plate warming apparatus.

### BACKGROUND OF THE INVENTION

In general, preparing a meal, such as for family members or guests, may include preparing and warming/cooking various food items across various food groups. For example, a generic dinner meal may include a meat, a vegetable, and a starch. Preparing and serving meals may generally include careful planning and timing in order to deliver warm food. One of the challenges faced by chefs, or individuals responsible for preparing meals, is serving the meal with each of the food items warm, as food items tend to cool quickly once plated. Further, food items may cool at different rates, such that some food items may be hot and others may be cooler by the time of serving the meal.

A typical method used in households/kitchens to keep food warm are warming appliances, such as ovens or standalone appliances, where food items and plates can be placed within to keep the food items warm until ready to be served. However, warming appliances may be bulky countertop appliances, oven appliances, or otherwise take up precious space in the household/kitchen. Other typical solutions include hot plates or heat lamps, which provide limited control over the intensity of the heat, sometimes resulting in dried out food.

Accordingly, an improved plate warming assembly and accompanying systems and methods for controlling the plate warming assembly would be useful.

### BRIEF DESCRIPTION OF THE INVENTION

Aspects and advantages of the invention will be set forth in part in the following description, or may be apparent from the description, or may be learned through practice of the invention.

In a first example embodiment, a method of operating a plate warmer is provided. The plate warmer defines a vertical direction, a lateral direction, and a transverse direction. The vertical, lateral, and transverse directions are mutually perpendicular. The plate warmer is defined between a top side and a bottom side along the vertical direction. The plate warmer includes a heating element between the top side and the bottom side. A heating zone is in thermal communication with the heating element. A controller is positioned within the plate warmer. The controller is in signal communication with an external device. The method includes receiving data from the external device indicative of a heating instruction and operating a heating element in response to the heating instruction.

In a second example embodiment, a method of operating a plate warmer is provided. The plate warmer defines a vertical direction, a lateral direction, and a transverse direction. The vertical, lateral, and transverse directions are mutually perpendicular. The plate warmer is defined between a top side and a bottom side along the vertical direction. The plate warmer includes a heating element between the top side and the bottom side. A heating zone is in thermal communication with the heating element. The plate warmer also includes a controller. The method includes detecting dishware placed within the heating zone of the plate warmer and operating the heating element in response to the detection of dishware placed within the heating zone of the plate warmer.

In another example embodiment, a plate warmer is provided. The plate warmer defines a vertical direction, a lateral direction, and a transverse direction. The vertical, lateral, and transverse directions being mutually perpendicular. The plate warmer is defined between a top side and a bottom side. The plate warmer includes a heating element between the top side and the bottom side and a heating zone in thermal communication with the heating element. A controller is in signal communication with an external device. The controller is configured to receive data from the external device indicative of a heating instruction and operate the heating element in response to the heating instruction.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an example embodiment of a plate warmer assembly according to aspects of the present disclosure.

FIG. 2 provides a schematic view of the example embodiment of the plate warmer assembly of FIG. 1 according to aspects of the present disclosure.

FIG. 3 provides a schematic of a plurality of plate warmers according to aspects of the present disclosure.

FIG. 4 provides an exploded, perspective view of an example plate warmer according to aspects of the present disclosure.

FIG. 5 provides an electrical diagram of the example plate warmer of FIG. 4 according to aspects of the present disclosure.

FIG. 6 illustrates a side, section view of an example plate warmer according to aspects of the present disclosure.

FIG. 7 illustrates an example network according to aspects of the present disclosure.

FIG. 8 provides a flow diagram of an example method of controlling a plate warmer assembly according to aspects of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

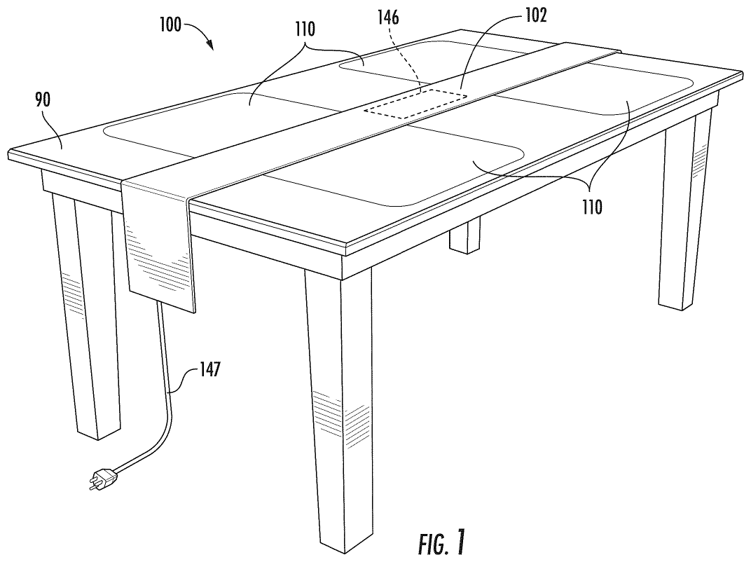

FIG. 1 provides a perspective view of a plate warming assembly 100 positioned on an example table 90. Table 90 is provided for example contextual purposes and is non-limiting to the example embodiments of the present example subject matter. In general, plate warming assembly 100 may include a hub 102 and one or more plate warmers 110. In some example embodiments, hub 102 may be excluded in plate warming assembly 100. Plate warmer 110 may generally include modular connection points configured to contact complementary connection points of hub 102, such that hub 102 and plate warmer 110 are electrically connected. In general, hub 102 may include one or more of a battery 146 or a power cord 147 for providing power to plate warmer 110. The modularity, powering, and heating of plate warmer 110 will be described in further detail hereinbelow.

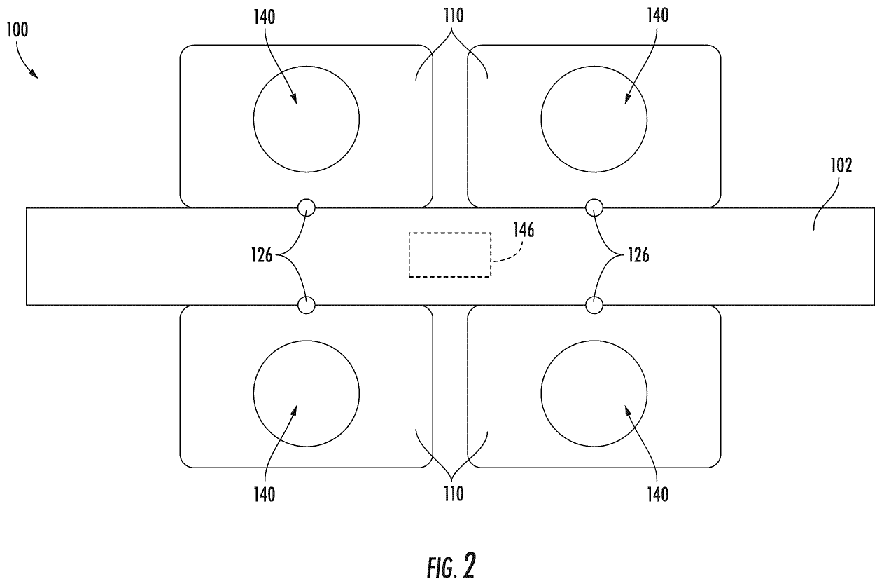

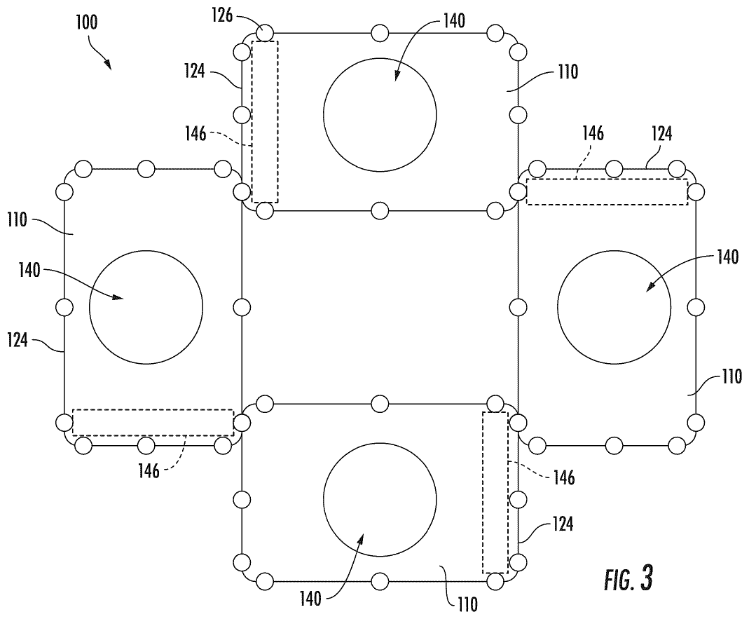

Looking now at FIGS. 2 and 3, illustrated are example embodiments of plate warmer assembly 100. In particular, FIG. 2 illustrates an example embodiment of plate warmer assembly 100 with four (4) plate warmers 110 connected to hub 102 via connectors 126. In general, connectors 126 may be contact plate connectors, or any other suitable type of connector whereby the plate warmers 110 may be interchangeably positioned around hub 102. Furthermore, FIG. 3 illustrates an example embodiment of plate warmer assembly 100 with four (4) plate warmers 110 directly connected to one another without hub 102. In some example embodiments, four (4) plate warmers 110 may each be connected to a central power supply/battery 146, and thereby are indirectly connected to every other plate warmer 110. In the present example embodiment, each plate warmer 110 may include a battery 146 positioned along one side for powering each plate warmer 110. In general, plate warmer 110 may be flexible, such as to roll up for storage when not in use. For example, the flexibility of plate warmer 110 may include bending, i.e., rolling, plate warmer 110 into a roll with an outer diameter of between three (3) inches and ten (10) inches, such as between four (4) inches and nine (9) inches, such as between five (5) inches and eight (8) inches. As such, positioning battery 146 along one side allows plate warmer 110 to roll up around battery 146. In some other example embodiments, plate warmer 110 may include a power cord in addition to or in place of battery 146.

Furthermore, each plate warmer 110 may include a plurality of connectors 126 positioned around an exterior edge 124 of each plate warmer 110. Accordingly, two or more plate warmers 110 may be positioned, paired, and/or oriented in any suitable manner or configuration as desired by a user. As seen in the example embodiments of FIGS. 2 and 3, plate warmer 110 may include a heating zone 140. In general, heating zone 140 may provide heat to items placed thereon, as will be explained in further detail hereinbelow. In general, heating zone 140 may be defined by a flexible base 130, a first flexible layer 134, and/or a second flexible layer 136 as will be further described hereinbelow. In general, outside of heating zone 140 on plate warmer 110, is non-heated, such that silverware or other utensils/objects may be placed on plate warmer 110 without being heated, as will be explained hereinbelow.

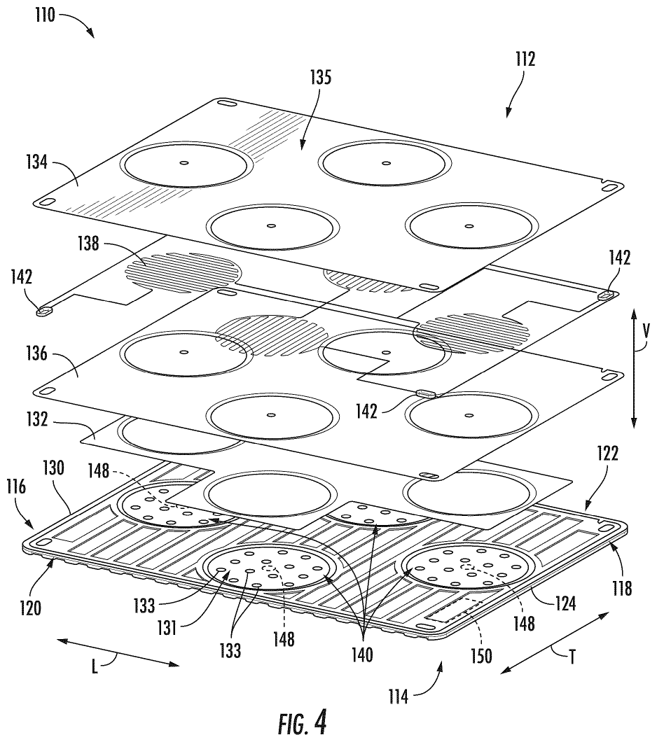

Turning now to FIG. 4, provided is an exploded view of an example embodiment of plate warmer 110. In general, plate warmer 110 may include multiple heating zones 140, such as is shown in FIG. 4 where plate warmer 110 includes four (4) heating zones 140. In general, plate warmer 110 is shown in the present disclosure with one (1) heating zone 140 (FIGS. 2 and 3) and with four (4) heating zones 140 (FIG. 4), however, it would be understood that plate warmer 110 may include any suitable amount of heating zones, such as two (2) heating zones 140, three (3) heating zones 140, or five (5) or more heating zones 140.

As may be seen in FIG. 4, plate warmer 110 may define a vertical direction V, a lateral direction L, and a transverse direction T. The vertical, lateral, and transverse directions may be mutually perpendicular. In particular, plate warmer 110 may be defined between a top side 112 and a bottom side 114 in the vertical direction V, and exterior edge 124 extending around a first side 116 and a second side 118 in the lateral direction L, and a front side 120 and a back side 122 in the transverse direction T. In general, plate warmer 110 may include a flexible base 130. For example, flexible base 130 may be comprised of any suitable flexible material, such as silicone, neoprene foam, or other similar materials, and combinations thereof. Flexible base 130 may generally define heating zone(s) 140, e.g., such as with a recess in the vertical direction V, as seen in FIG. 4. In general, an upper layer may be positioned above flexible base 130, in the vertical direction V. In particular, the upper layer may be or may include a heat shield 132, such as a foil layer, generally positioned over the heating zone(s) 140.

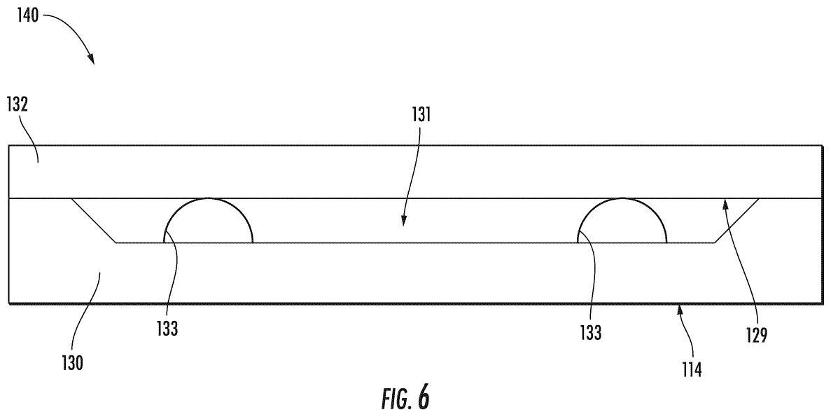

Turning ahead briefly to FIG. 6, in general, within heating zone 140, flexible base 130 may include a standoff 133 defining an air pocket 131 between the upper layer (e.g., heat shield 132) and the bottom side 114 of plate warmer 110. More specifically, standoff 133 may trap air between bottom side 129 of heat shield 132 of flexible base 130. Some example embodiments, such as the example embodiment seen in FIG. 4, may include a plurality of standoffs 133 defining air pockets 131 between flexible base 130 and heat shield 132. In general, the air pocket (or plurality of air pockets) 131 defined by standoff (or plurality of standoffs) 133 may reduce heat transfer out of bottom side 114 of plate warmer 110. In general, standoff 133 may be any suitable shape or size to define the air pocket 131 between bottom side 129 of heat shield 132 of flexible base 130. For example, as shown in FIG. 6 standoff 133 may be hemispherical, however, in other example embodiments, standoff 133 may be cylindrical, conical, cubical, or any other suitable shape.

In general, plate warmer 110 may include a first flexible layer 134 positioned above flexible base 130. First flexible layer 134 may generally be fiber-reinforced silicone. In general, first flexible layer 134 may define a non-heating zone 135 around heating zone(s) 140 on top side 112 of plate warmer 110. In general, non-heating zone 135 may be surface area of top side 112 of plate warmer 110 outside of heating zone 140 where silverware or other utensils/objects may be placed on plate warmer 110 without being heated. Plate warmer 110 may generally include a second flexible layer 136 positioned between first flexible layer 134 and flexible base 130. Second flexible layer 136 may be any suitable flexible material, such as fiber-reinforced silicone. In particular, a heating element 138 may be positioned between first flexible layer 134 and second flexible layer 136. In general, heating element(s) 138 may be aligned with heating zone(s) 140 of flexible base 130 with respect to the vertical direction V. In general, heating element(s) 138 may be resistive heating elements, such as a wound-wire heating element (e.g., nichrome), a thick-film heating element (e.g., conductive composite polymer on polymer substrate), or a thin-film heating element (e.g., etched/printed foil on polymer substrate). Plate warmer 110 may generally include a complementary amount of heating element(s) 138 as heating zone(s) 140 provided on plate warmer 110. For example, the present example embodiment includes four (4) heating zones 140 and accordingly includes four (4) heating elements 138. In general, heating elements 138 may be powered by one of battery 146 or power cord 147 to provide specified amounts of heat, as will be explained further herein below.

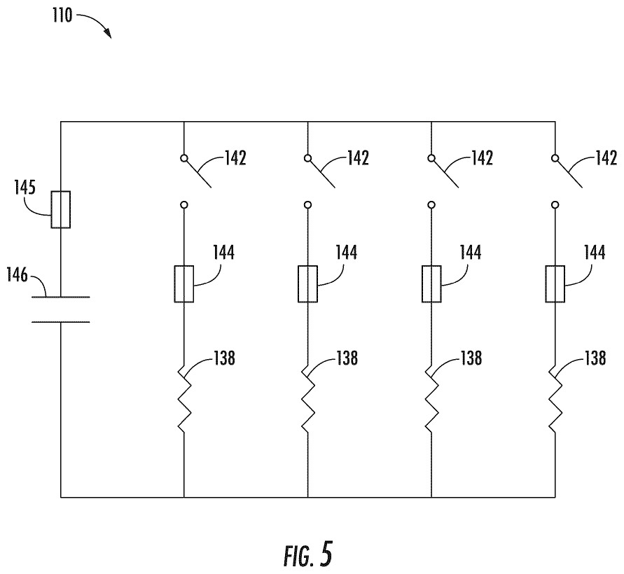

Turning now to FIG. 5, illustrated is an electrical diagram of the example plate warmer of FIG. 4. In general, a switch 142 and a fuse 144 may be in electrical communication with each respective heating element 138. In particular, each switch 142 may be configured to activate/deactivate the respective heating element 138, such that each heating element 138 may be independently controlled. In general, fuse 144 may regulate each respective heating element 138, such as limiting power in abnormal conditions. Furthermore, plate warmer 110 may include a main fuse 145 connected in series with the power source, i.e., battery 146 (or power cord 147). Particularly, main fuse 145 may limit the total power draw in plate warmer 110.

Turning again to FIG. 4, plate warmer 110 may include a controller 150 positioned within plate warmer 110, such as within flexible base 130. Operation of plate warmer 110 may be regulated by controller 150. Controller 150 may be operatively coupled or in communication with various components of plate warmer 110, including heating element 138 and switch 142. In response to user manipulation of switch 142, controller 150 may operate heating element 138 of plate warmer 110 to execute selected cycles and features.

Controller 150 may include a memory and microprocessor, such as a general or special purpose microprocessor operable to execute programming instructions or micro-control code associated with a heating cycle. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 150 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software. Switch 142 and other components of plate warmer 110 may be in communication with controller 150 via one or more signal lines or shared communication busses.

For example, controller 150 may be operable to execute programming instructions or micro-control code associated with a heating cycle of plate warmer 110. In this regard, the instructions may be software or any set of instructions that when executed by the processing device, cause the processing device to perform operations, such as running one or more software applications, receiving user input, processing user input, etc. Moreover, it should be noted that controller 150 as disclosed herein is capable of and may be operable to perform any methods, method steps, or portions of methods as disclosed herein. For example, in some embodiments, methods disclosed herein may be embodied in programming instructions stored in the memory and executed by controller 150.

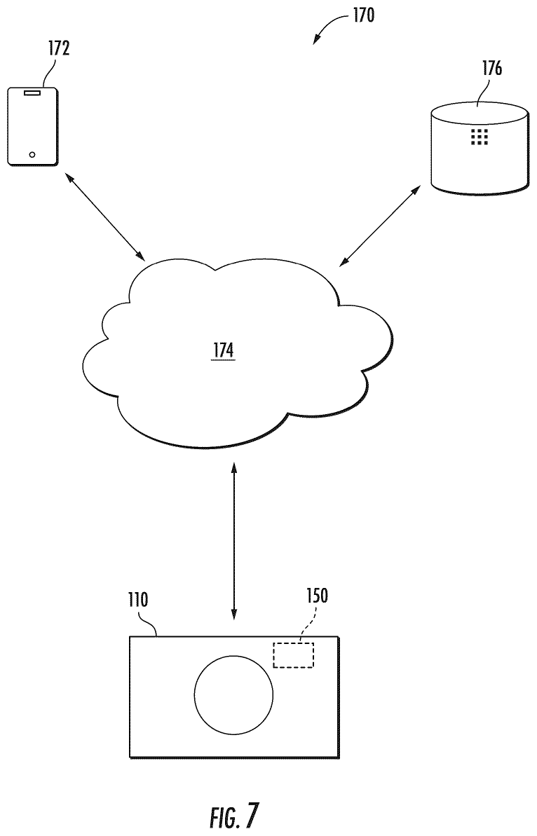

Turning to FIG. 7, controller 150 may be in wireless communication with an external device, such as one or more of a smartphone 172, referred to generally as external device 172, another appliance (such as an oven appliance or a refrigerator appliance), and a database 176, over a network 174. In particular, FIG. 7 illustrates a schematic diagram of an external communication system 170 which will be described according to an example embodiment of the present subject matter. In general, external communication system 170 is configured for permitting interaction, data transfer, and other communications between plate warmer 110 and one or more external devices. For example, this communication may be used to provide and receive operating parameters, user instructions or notifications, performance characteristics, user preferences, or any other suitable information for improved performance of plate warmer 110. In addition, it should be appreciated that external communication system 170 may be used to transfer data or other information to improve performance of one or more external devices or appliances and/or improve user interaction with such devices.

For example, external communication system 170 permits controller 150 of plate warmer 110 to communicate with a separate device external to plate warmer 110, such as external device 172 and/or database 176. These communications may be facilitated using a wired or wireless connection, such as via network 174. In general, external device 172 may be any suitable device separate from plate warmer 110 that is configured to provide and/or receive communications, information, data, or commands from a user. In this regard, external device 172 may be, for example, a personal phone, a smartphone, a tablet, a laptop or personal computer, a wearable device, or another mobile or remote device.

In addition, a remote server, or database 176 may be in communication with plate warmer 110 and/or external device 172 through network 174. In this regard, for example, database 176 may be a cloud-based server, and is thus located at a distant location, such as in a separate state, country, etc. According to an example embodiment, external device 172 may communicate with database 176 over network 174, such as the Internet, to transmit/receive data or information, provide user inputs, receive user notifications or instructions, interact with or control plate warmer 110, etc. In addition, external device 172 and database 176 may communicate with plate warmer 110 to communicate similar information.

In general, communication between plate warmer 110, external device 172, database 176, and/or other user devices or appliances may be carried using any type of wired or wireless connection and using any suitable type of communication network, non-limiting examples of which are provided below. For example, external device 172 may be in direct or indirect communication with plate warmer 110 through any suitable wired or wireless communication connections or interfaces, such as network 174. For example, network 174 may include one or more of a local area network (LAN), a wide area network (WAN), a personal area network (PAN), the Internet, a cellular network, any other suitable short- or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 170 is described herein according to an example embodiment of the present subject matter. However, it should be appreciated that the example functions and configurations of external communication system 170 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

For example, controller 150 may communicate with external device 172 and/or database 176 to determine a specified temperature or power level for the heating element to keep the prepared food items warm. In particular, determining the specified temperature/power level may include plate warmer 110 communicating with database 176, or other household appliances to determine what food items were prepared. For example, an oven appliance (such as wall oven or microwave oven appliances) or a refrigerator appliance may communicate with controller 150 information about a type of food being prepared. In particular, a refrigerator appliance may include an inventory system configured to identify food items within the refrigerator appliance, and when a particular food item is removed, temperature instruction may be received by controller 150 relevant to the particular food item. Or, in another example scenario, an oven appliance may bake food at a specified temperature setting, and controller 150 may receive temperature instruction to be a percentage of the specified temperature setting, such as fifty percent (50%) or less, such as forty percent (40%) or less, such as thirty percent (30%) or less. For example, when an oven is operating at four hundred degrees Fahrenheit (400° F.), controller 150 may receive heating instruction to heat plate warmer 110 to the specified temperature of one hundred and twenty degrees Fahrenheit (120° F.), e.g., thirty percent (30%) of the oven temperature. Furthermore, certain foods may benefit from different heat levels. For example, broccoli or zucchini generally may cool-down relatively quickly once plated, and thus may require a higher heat setting, such as one hundred and forty-five degrees Fahrenheit (145° F.). On the other hand, chocolate in chocolate chip cookies may melt if overheated, and thus one hundred degrees Fahrenheit (100° F.) may be set to reduce the undesired melting.

Accordingly, plate warmer 110 may be configured to operate at a specified temperature in response to information communicated through external communication system 170 about the specific food that has been prepared. In some example embodiments, controller 150 may also receive user inputs indicative of a desired temperature. For example, other example embodiments may include an oven appliance and/or an over-the-range microwave appliance outfitted with a camera and image-recognition software configured to determine food type, or an app on a mobile device may be used to determine food type, such as through using image recognition or user input selecting a food type. In general, an external device may communicate with plate warmer 110 to define the heat setting.

Turning back to FIG. 4, plate warmer 110 may include a sensor 148 positioned within heating zone 140 of flexible base 130 (e.g., or first flexible layer 134/second flexible layer 136). In general, sensor 148 may be in signal communication with controller 150. In general, sensor 148 may be configured to detect dishware placed within heating zone 140 of plate warmer 110. For example, sensor 148 may include one of an optical sensor, a weight detection circuit, and/or a strain gauge. Accordingly, controller 150 may be configured to activate (or deactivate) respective heating elements 138 in response to the detection of dishware placed upon plate warmer 110. For example, heating element 138 may be deactivated, e.g., providing no heat, when no dishware is detected in heating zone 140, and may activate upon controller 150 detecting dishware placed thereon.

In some example embodiments, the temperature of heating element 138 may be controlled passively by a positive temperature coefficient (PTC) device that may increase resistance with temperature. In other words, as the heating element 138 warms up, the PTC device's resistance increases and the power delivered to the heating element 138 drops. Alternatively, a secondary heater may be positioned in proximity to the PTC device instead of using the output from the heating element 138 to warm the PTC device. Additionally or alternatively, heating element 138 temperature may be controlled actively by a temperature-sensing device (e.g., a thermistor) within or on the surface of the plate warmer 110. The output from this temperature-sensing device may be received by controller 150, and thereby used to regulate power to heating element 138.

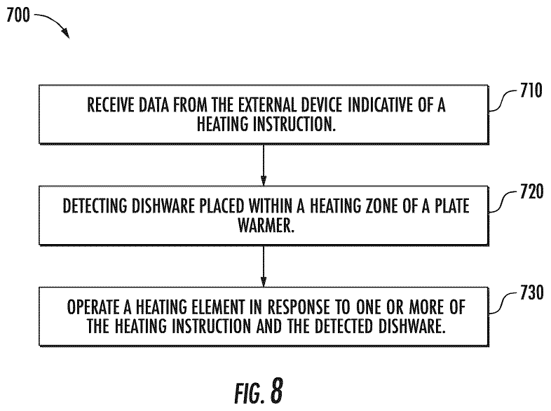

Turning now to FIG. 8, a flow diagram of one embodiment of a method 700 of operating plate warmer 110 is illustrated in accordance with aspects of the present subject matter. In general, method 700 will be described herein with reference to the embodiments of plate warmer 110 described above with reference to FIGS. 1-6. However, it should be appreciated by those of ordinary skill in the art that the disclosed method 700 may generally be utilized in association with apparatuses and systems of plate warmers having any other suitable configuration. In addition, although FIG. 8 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 8, at (710), method 700 may generally include receiving data from the external device indicative of a heating instruction. As stated above, information may be communicated through external communication system 170, e.g., via external device 172, about the specific food that has been prepared (and may be placed on plate warmer 110). For example, external device 172 may transmit data indicative of chicken breast being prepared, and that the specified “keep warm” temperature of heating element 138 may be about one hundred and seventy degrees Fahrenheit (170° F.).

At (730), method 700 may generally include operating the heating element in response to the heating instruction. For example, heating element 138 of plate warmer 110 may be configured to operate at the specified temperature in response to the information received through external communication system 170 about the specific food that has been prepared. Accordingly, continuing the above chicken breast example, the specified “keep warm” temperature of heating element 138 may be about one hundred and seventy degrees Fahrenheit (170° F.), whereupon controller 150 may operate heating element 138 at one hundred and seventy degrees Fahrenheit (170° F.) in order to keep the chicken breast warm.

At (720), method 700 may generally include detecting dishware placed within the heating zone of the plate warmer. In general, the detection of dishware in step (720) may be performed without, or independently from, receiving data from the external device in step (710). For example, sensor 148 may detect when dishware is placed on heating zone 140 via optical detection, weight detection, or electrical resistance detection (i.e., strain gauge). As stated above, heating element 138 may be deactivated, e.g., providing no heat, when no dishware is detected in heating zone 140. As such, at (730), method 700 may further include operating the heating element in response to the detection of dishware placed within the heating zone of the plate warmer. For example, heating element 138 of plate warmer 110 may be configured to activate in response to the detection of dishware placed within the heating zone of the plate warmer.

As may be seen from the above, provided is an improved plate warming assembly and methods for controlling the plate warming assembly. The plate warmer of the plate warming assembly may be modular such as to provide various suitable configurations per the desire of the user. The plate warmer may include an internal air gap in order to reduce heat transfer through the bottom of the plate warmer. Furthermore, the plate warmer may communicate with external devices over a network to receive information, such as information indicating the optimal “keep warm” temperature for a specific food being prepared. Additionally, the heating element of the plate warmer may activate contingent upon detection of an object, i.e., dishware, over the heating zone.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating a plate warmer, the plate warmer defining a vertical direction, a lateral direction, and a transverse direction, the vertical, lateral, and transverse directions being mutually perpendicular, the plate warmer defined between a top side and a bottom side along the vertical direction, the plate warmer comprising a heating element between the top side and the bottom side, a heating zone in thermal communication with the heating element, and a controller, the controller in signal communication with an external device, the method comprising:
receiving, by the controller, data from the external device indicative of a heating instruction; and
operating, by the controller, the heating element in response to the heating instruction.

2. The method of claim 1, further comprising detecting, by the controller, dishware placed within the heating zone of the plate warmer, whereby operating the heating element is in response to one or more of the heating instruction and the detected dishware placed within the heating zone of the plate warmer.

3. The method of claim 2, further comprising a sensor positioned within the heating zone, the sensor in signal communication with the controller, wherein the sensor comprises one of an optical sensor, a weight detection circuit, and a strain gauge, wherein detecting the dishware placed within the heating zone by the controller comprises receiving a signal from the sensor to detect the dishware placed within the heating zone of the plate warmer.

4. The method of claim 1, wherein the plate warmer further comprises a flexible base and an upper layer positioned above the flexible base, the heating zone defined in the flexible base, wherein the upper layer comprises a heat shield, and wherein the heat shield is positioned over the heating zone of the flexible base.

5. The method of claim 4, wherein the plate warmer further comprises a first flexible layer positioned above the flexible base, the first flexible layer defining a non-heating zone on the top side of the plate warmer.

6. The method of claim 5, wherein the plate warmer further comprises a second flexible layer positioned between the first flexible layer and the flexible base.

7. The method of claim 6, wherein the heating element is positioned between the first flexible layer and the second flexible layer, the heating element aligned with the heating zone of the flexible base in the vertical direction.

8. A method of operating a plate warmer, the plate warmer defining a vertical direction, a lateral direction, and a transverse direction, the vertical, lateral, and transverse directions being mutually perpendicular, the plate warmer defined between a top side and a bottom side along the vertical direction, the plate warmer comprising a heating element between the top side and the bottom side, a heating zone in thermal communication with the heating element, and a controller, the method comprising:
detecting, by the controller, dishware placed within the heating zone of the plate warmer; and
operating, by the controller, the heating element in response to the detected dishware placed within the heating zone of the plate warmer.

9. The method of claim 8, wherein the controller is in signal communication with an external device, further comprising receiving, by the controller, data from the external device indicative of a heating instruction, whereby operation of the heating element is in response to one or more of the heating instruction and the detected dishware placed within the heating zone of the plate warmer.

10. The method of claim 8, wherein the plate warmer further comprises a sensor positioned within the heating zone, the sensor in signal communication with the controller, wherein the sensor comprises one of an optical sensor, a weight detection circuit, and a strain gauge, wherein detecting the dishware placed within the heating zone by the controller comprises receiving a signal from the sensor to detect the dishware placed within the heating zone of the plate warmer.

11. The method of claim 8, wherein the plate warmer further comprises a flexible base, and an upper layer positioned above the flexible base, the heating zone defined in the flexible base, wherein the upper layer comprises a heat shield, and wherein the heat shield is positioned over the heating zone of the flexible base.

12. The method of claim 11, wherein the plate warmer further comprises a first flexible layer positioned above the flexible base, the first flexible layer defining a non-heating zone on the top side of the plate warmer.

13. The method of claim 12, wherein the plate warmer further comprises a second flexible layer positioned between the first flexible layer and the flexible base.

14. The method of claim 13, wherein the heating element is positioned between the first flexible layer and the second flexible layer, the heating element aligned with the heating zone of the flexible base in the vertical direction.

15. A plate warmer defining a vertical direction, a lateral direction, and a transverse direction, the vertical, lateral, and transverse directions being mutually perpendicular, the plate warmer defined between a top side and a bottom side along the vertical direction, the plate warmer comprising:
a heating element between the top side and the bottom side;
a heating zone in thermal communication with the heating element; and
a controller, the controller in signal communication with an external device, the controller configured to:
receive data from the external device indicative of a heating instruction; and
operate the heating element in response to the heating instruction.

16. The plate warmer of claim 15, wherein the controller is further configured to detect dishware placed within the heating zone of the plate warmer.

17. The plate warmer of claim 16, further comprising a sensor positioned within the heating zone of the plate warmer, the sensor in signal communication with the controller, wherein the sensor comprises one of an optical sensor, a weight detection circuit, and a strain gauge, wherein the controller is configured to detect dishware placed within the heating zone of the plate warmer based on a signal received by the controller from the sensor.

18. The plate warmer of claim 15, further comprising a flexible base, an upper layer positioned above the flexible base, wherein the flexible base comprises a standoff defining an air pocket between the upper layer and the bottom side of the plate warmer, wherein the standoff defining the air pocket is one of a plurality of standoffs defining air pockets in the flexible base, the plurality of standoffs configured to reduce heat transfer out of the bottom side of the plate warmer.

19. The plate warmer of claim 15, further comprising a connector positioned at an exterior edge of the plate warmer.

20. The plate warmer of claim 15, further comprising a flexible base and an upper layer positioned above the flexible base, the heating zone defined in the flexible base, wherein the upper layer comprises a heat shield, wherein the heat shield is positioned over the heating zone of the flexible base.
